(19) United States
(12) Patent Application Publication
(10) Pub. No.: US 2025/0151769 A1
(43) Pub. Date: May 15, 2025

(54) METHOD FOR MANUFACTURING A STICK SHAPE MELTABLE SOLID

(71) Applicant: Amy Nunez, Palm Desert, CA (US)

(72) Inventor: Amy Nunez, Palm Desert, CA (US)

(21) Appl. No.: 18/943,888

(22) Filed: Nov. 11, 2024

Related U.S. Application Data
(60) Provisional application No. 63/548,173, filed on Nov. 11, 2023.

(51) Int. Cl. A23L 35/00; A23L 3/44

(52) U.S. Cl. CPC A23L 35/00; A23B 2/92

(57) ABSTRACT

A hand-held stick shaped meltable solid is provided, which may be picked up with a raking motion or placed into someone's hand for them to hold. In accordance with the present invention, the shape of the meltable solid allows a child or adult to bring the food to their mouth to practice a bite in the front of the mouth or on the back molars, which supports practicing biting and chewing with a safe transitional texture. The flavors will be precisely what is on the label without additives. Using freeze-drying, the product will maintain its freshness, and preserve its flavor, and consistency for a significantly longer time than other meltables currently available in the marketplace.

### CO-RELATED APPLICATION

This application claims the benefit of a provisional patent having application No. 63/548,173 entitled “Stick Shape Meltable Solid” having a filing date on Nov. 11, 2024.

### FIELD OF THE INVENTION

The present invention is directed to the manufacture of a stick shape meltable solid, which may be used in the field of transitional food and more particularly for use in therapy, or for a modified diet, for children and adults with dysphagia and/or a pediatric feeding disorder.

### BACKGROUND OF THE INVENTION

Dysphagia refers to difficulty in swallowing, and it can affect individuals of all ages, including both children and adults. When managing dysphagia, meltable foods can be a suitable option for individuals who struggle with swallowing solid foods. They are designed to easily dissolve in the mouth without requiring excessive chewing or swallowing ability.

Meltables often come in the form of snacks or treats that are soft, easily dissolvable, and can melt quickly upon contact with saliva. Some examples of meltable foods include puffs, crisps, rice cakes, yogurt melts, ice chips, and certain types of cookies. These foods provide a safe and convenient alternative for individuals with dysphagia to enjoy a variety of textures and flavors while minimizing the risk of choking or discomfort during swallowing.

More particularly, current meltable solids are in the shape of a small circle, which are not accessible to children and adults with fine motor difficulties and may cause choking of the child or adult having dysphagia who cannot chew up the meltable. Additionally, current meltables may expire and change consistency in just a few days after being opened. In addition, the current meltables on the market come in a variety of flavor combinations, which may be challenging to process as an adult or child with a sensory feeding disorder. Lastly, meltables, which contain additives, preservatives, flavors, and other combinations of ingredients may cause a change in the nutritional value of the food product.

More specifically, current meltable solids on the market are in a small circle shape with mixed flavors. They contain additives, preservatives, additional colors, and flavors. These meltables must be used within hours or days of opening and require the ability to chew repetitively to break them down. The small circular shape can be a potential choking hazard for a child or adult with swallowing difficulty as well as difficulty picking up if they do not have the motor ability to do a pincer grasp. There are children and adults who have hypersensitivity to flavors, therefore, mixed flavors can be too difficult to process. Families do not see the benefit in buying a meltable that will not last long after opening or may not know the risk of the meltable changing its texture after opening and giving it to their loved one, who may choke on this new texture. Lastly, the nutritional value is lacking due to being processed and additives given.

Therefore, what is needed is a meltable solid that allows a child or adult to bring the food to their mouth to practice a bite in the front of the mouth or on the back molars, which supports practicing biting and chewing with a safe transitional texture. The meltable solid of the present invention solves this problem in a new and unique fashion.

### SUMMARY OF THE INVENTION

A hand-held stick shaped meltable solid is provided, which may be picked up with a raking motion or placed into someone's hand for them to hold. In accordance with the present invention, the shape of the meltable solid allows a child or adult to bring the food to their mouth to practice a bite in the front of the mouth or on the back molars, which supports practicing biting and chewing with a safe transitional texture. The flavors will be precisely what is on the label without additives. Using freeze-drying, the product will maintain its freshness, and preserve its flavor, and consistency for a significantly longer time than other meltables currently available in the marketplace.

### BRIEF DESCRIPTION OF THE DRAWINGS

FIG. 1 is a perspective view of a hand-held stick shaped meltable solid in accordance with the present invention.

### DESCRIPTION OF THE INVENTION

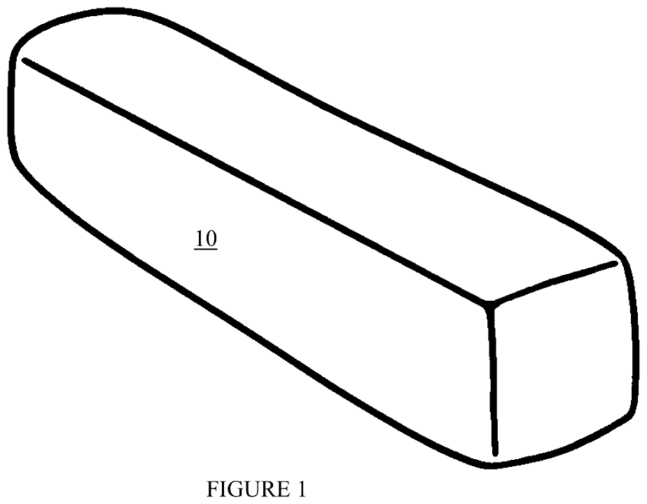

Referring now to FIG. 1, there is shown a hand-held stick-shaped meltable solid 10, which may be picked up using the palm of your hand with a raking motion or placed into someone's hand for them to hold is disclosed. The current meltable solids on the market are in a small circle shape with mixed flavors as opposed to the current invention which is sticked-shaped which doesn't require the ability to chew repetitively or with great strength before swallowing. The stick-shaped meltable solid 10 of the current invention comes in single flavors, provides increased nutritional value, as well as a longer shelf life.

It should be noted that the hand-held stick-shaped meltable solid 10 of the present invention is more accessible for people who do not have a pincer grasp. It is a true meltable solid, which does not require repetitive chewing or a strong bite. the hand-held stick-shaped meltable solid 10 of the present invention comes in single flavors, which makes it easier for people with hypersensitivity to flavor to know what flavor they are eating, which supports explorations of flavors. However, flavors may be mixed depending on individual preference. The hand-held stick-shaped meltable solid 10 of the present invention has increased nutritional value due to it being made only with what is labeled. Lastly, it has an increased shelf life, which will allow families to enjoy it for much longer without the risk of choking or needing to throw it away after a few days.

The hand-held stick-shaped meltable solid 10 of the present invention may be prepared to create a specific shape and consistency, which may be accessible for a person with disorders in fine motor skills as well as a safe meltable solid for a person with dysphagia. In addition, following the method outlined below will create a product which will have an increase in nutritional value and shelf life. Lastly, the flavor may be individualized by preference. The method for creating the hand-held stick-shaped meltable solid 10 of the present invention is accomplished using the following steps:
1. Select source plant and animal products (This product could be made with other sources of produce and dairy (nondairy milk substitutions such as coconut, oat, almond, rice, hemp, flax, cashew) as well as meat/poultry/fish/legumes.)
2. Prepare plant and animal products.) by adding water at varying amounts (This product may be shredded, minced, mashed, emulsified, blended, pressed, diced, sliced, chopped, kneaded, and/or cut into strips.
3. Place product in a silicone mold (This product may be placed into any shaped stick silicone mold.)
4. Place into a freeze dryer
5. Package the product (This product may be packaged in any container or bag with an oxygen absorber.)

In summary, all elements are necessary. All elements must be followed step by step, wherein you will need to buy food that you would like to use according to a client's specific modified diet and preference. Then, you will prepare the food to be placed into the silicone mold. Then, you will place the silicone mold into the freeze dryer. Then, turn the freeze dryer on. Once it is complete, carefully remove the product from the silicone mold. Then, place the product into the container and/or bag. Then, put the oxygen absorber into the bag. Lastly, seal the bag.

The hand-held stick-shaped meltable solid 10 of the present invention serves as a meltable solid/transitional food used for a person who has a diagnosis of dysphagia or a pediatric feeding disorder, who is transitioning from a pureed diet to eating a minced moist and/or soft and bite-sized texture. The meltable solid stick may be placed on a table to be picked up or placed in someone's hand. It may then be brought to the mouth, and it requires no biting, minimal chewing, and pressure from the client's tongue can break it down.

Due to the stick shape, the therapist/caregiver/client can place the food either in the front of the mouth or on the back molars to target specific motor skills safely. In addition, this meltable solid can help transition children with hypersensitivity to flavor and texture to trying novel foods by using food chaining or food hierarchies. The hand-held stick-shaped meltable solid of the present invention could be used as a snack for ages six months to adults and as someone's emergency food supply, and as a transitional solid for typical babies transitioning to solid foods.

While the present invention has been described with reference to a particular hand-held stick-shaped meltable solid 10, it should be understood that hand-held shaped meltable solids are illustrative and that the scope of the invention is not limited to a hand-held stick-shaped meltable solid. Many variations, modifications, additions, and improvements to shaped meltable solids are possible. It's contemplated that these variations, modifications, additions, and improvements fall within the scope of the invention.

What is claimed is:

1. A meltable solid comprising:
A hand-held stick shaped meltable solid defining a safe transitional texture,
wherein said shape of said hand-held stick shaped meltable solid allows a person to bring food to their mouth to practice biting by picking up said hand-held stick shaped meltable solid to a person's mouth for practicing biting and chewing using said safe transitional texture.

2. The meltable solid according to claim 1, further comprising practicing biting using the front of a person's mouth.

3. The meltable solid according to claim 1, further comprising practicing biting using the back molars of a person's mouth.

4. The meltable solid according to claim 1, further comprising said person being a child.

5. The meltable solid according to claim 1, further comprising said person being an adult.

6. The meltable solid according to claim 1, further comprising picking up said hand-held stick shaped meltable solid using a raking motion.

7. The meltable solid according to claim 1, further comprising picking up said hand-held stick shaped meltable solid by placing said hand-held stick shaped meltable solid into someone's hand for them to hold.

8. The meltable solid according to claim 1, further comprising freeze drying said hand-held stick shaped meltable solid to maintain said hand-held stick shaped meltable solid freshness.

9. The method for manufacturing a stick shaped meltable solid comprising the steps of:
selecting a source plant and animal product;
preparing said plant and animal products;
placing said prepared product in a sticked shaped silicone mold producing a hand-held stick shaped meltable solid;
placing said hand-held stick shaped meltable solid into a freeze dryer, and
packaging said hand-held stick shaped meltable solid in any container or bag with an oxygen absorber.

10. The method for manufacturing a stick shaped meltable solid according to claim 9 further comprising the step of:
selecting a source plant and animal product made with other sources of produce and dairy as well as meat/poultry/fish/legumes
preparing said plant and animal
placing said product in a sticked shaped silicone mold producing a hand-held stick shaped meltable solid;
placing said hand-held stick shaped meltable solid into a freeze dryer, and
packaging said hand-held stick shaped meltable solid in any container having an oxygen absorber.

11. The method for manufacturing a stick shaped meltable solid according to claim 9 further comprising the step of:
selecting a source plant and animal product made with other sources of produce and dairy.

12. The method for manufacturing a stick shaped meltable solid according to claim 9 further comprising the step of:
selecting a source plant and animal product made with other sources of produce and dairy such as nondairy milk substitutions such as coconut, oat, almond, rice, hemp, flax, cashew.

13. The method for manufacturing a stick shaped meltable solid according to claim 9 further comprising the step of:
selecting a source plant and animal product made with other sources of animal product such as meat/poultry/fish/legumes.

14. The method for manufacturing a stick shaped meltable solid according to claim 9 further comprising the step of:
preparing said plant and animal products which may be shredded, minced, mashed, emulsified, blended, pressed, diced, sliced, chopped, kneaded.

15. The method for manufacturing a stick shaped meltable solid according to claim 9 further comprising the step of:
preparing said plant and animal products which may cut into strips.

16. The method for manufacturing a stick shaped meltable solid according to claim 9 further comprising the step of:
adding water at varying amounts when preparing said plant and animal products which may be shredded, minced, mashed, emulsified, blended, pressed, diced, sliced, chopped, kneaded and cut into strips.
